(19) United States
(12) Patent Application Publication
(10) Pub. No.: US 2009/0241683 A1
(43) Pub. Date: Oct. 1, 2009

(54) MASS AIR FLOW SENSOR ADAPTOR

(75) Inventors: Andrew P. Perr, Columbus, IN (US); Yongquan Chai, Columbus, IN (US)

Correspondence Address: CUMMINS, INC.;ATTN: INTELLECTUAL PROPERTY GROUP, 500 JACKSON STREET, COLUMBUS, IN, 47201, US

(73) Assignee: Cummins, Inc., Indianapolis, IN (US)

(21) Appl. No.: 12/057,772

(22) Filed: Mar. 28, 2008

(51) Int. Cl. G01F 1/00; F02M 35/10

(52) U.S. Cl. 73/861; 123/391; 73/198; 123/184.53

(57) ABSTRACT

Mass air flow sensing for internal combustion engines. In one aspect, a sensor adaptor for use in an internal combustion engine includes an inlet housing including an approximately 90-degree elbow and directing air within the inlet housing to the internal combustion engine in an airflow direction. A mass air flow sensor is coupled to the housing at a location after the 90-degree elbow with respect to the airflow direction and senses the air flowing within the inlet housing.

### FIELD OF THE INVENTION

The present invention relates to internal combustion engines, and more particularly to sensing mass air flow for internal combustion engines.

### BACKGROUND OF THE INVENTION

Sensors are used in internal combustion engines to measure air flow and flow of other gases to allow greater control over engine operation. For example, measuring air flow allows calculation of desired characteristics such as air-fuel injection ratios in an electronically fuel-injected engine. The air flow information is provided to an engine control unit (ECU) to calculate and deliver the correct fuel mass to the engine. The air flow measurement can also allow an engine to measure gasses to meet emissions standards, such as when using exhaust gas recirculation (EGR), which recirculates a portion of exhaust gas back to the engine cylinders and limits the generation of nitrous oxide.

Typically, air flow is measured using one or more sensors provided in appropriate locations in the engine. In some engines, a pressure sensor is used to sense a difference in pressure across an orifice, and a temperature sensor is used to sense air temperature, such that air flow can be determined. However, gas particulates build up and can block or distort the sensing ability of the sensors. In addition, these types of sensors tend to be costly.

In other engines, a mass air flow (MAF) sensor can be used instead of a pressure sensor and temperature sensor. Mass air flow (MAF), which relates to the mass of air flowing though or into an internal combustion engine, can be directly measured using this type of sensor provided in the air flow system for the engine. MAF sensors can be more reliable than pressure and temperature sensors to sense air flow or other gas flows, and are generally less expensive. For example, some engines include MAF sensors as part of a general engine air handling design.

However, engines using MAF sensors are generally tailored for a specific vehicle and do not have the flexibility to accommodate different types of vehicles without affecting the consistency of MAF sensor output. The air flow systems of different types of vehicles vary in their configuration and characteristics and can cause inconsistent MAF sensor performance depending on the air flow system characteristics. Thus existing MAF sensor devices can only be incorporated into an engine when an engine manufacturer designs the entire vehicle, including the engine and air flow system. This does not allow a single engine design with a MAF sensor to be manufactured and used with a variety of different types of vehicles.

Accordingly, a system and method for providing a mass air flow sensor system that can be used in a particular engine design and provides consistent output from the sensor when used with a variety of different vehicles or mechanisms, would be desirable in many applications.

### SUMMARY OF THE INVENTION

The invention of the present application relates to sensing mass air flow for internal combustion engines. In one aspect of the invention, a sensor adaptor for use in an internal combustion engine includes an inlet housing including an approximately 90-degree elbow and directing air within the inlet housing to the internal combustion engine in an airflow direction. A mass air flow sensor is coupled to the housing at a location after the 90-degree elbow with respect to the airflow direction and senses the air flowing within the inlet housing. A similar aspect is provided for an engine system and method for implementing similar features.

The present invention provides mass air flow sensing for an internal combustion engine, in which a low-cost mass air flow sensor can be provided for a single engine design or product that can be used in any of a variety of different vehicles and mechanisms, thus providing flexibility that accommodates variability in the air inlet and duct system connected to the engine.

### BRIEF DESCRIPTION OF THE FIGURES

FIG. 1 is a perspective view of an internal combustion engine portion including a mass air flow sensor adaptor of the present invention;

FIG. 2 is a perspective view of a 90-degree elbow section of the adaptor of the present invention;

FIGS. 3 and 4 are perspective views of the 90-degree section of the adaptor of the present invention; and

FIGS. 5A and 5B are sectional views of a portion of the adaptor of the present invention.

### DETAILED DESCRIPTION

The present invention relates to internal combustion engines, and more particularly to sensing mass air flow for internal combustion engines. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular components provided in particular implementations. However, one of ordinary skill in the art will readily recognize that this apparatus will operate effectively in other implementations and applications. For example, the systems usable with the present invention can take a number of different forms.

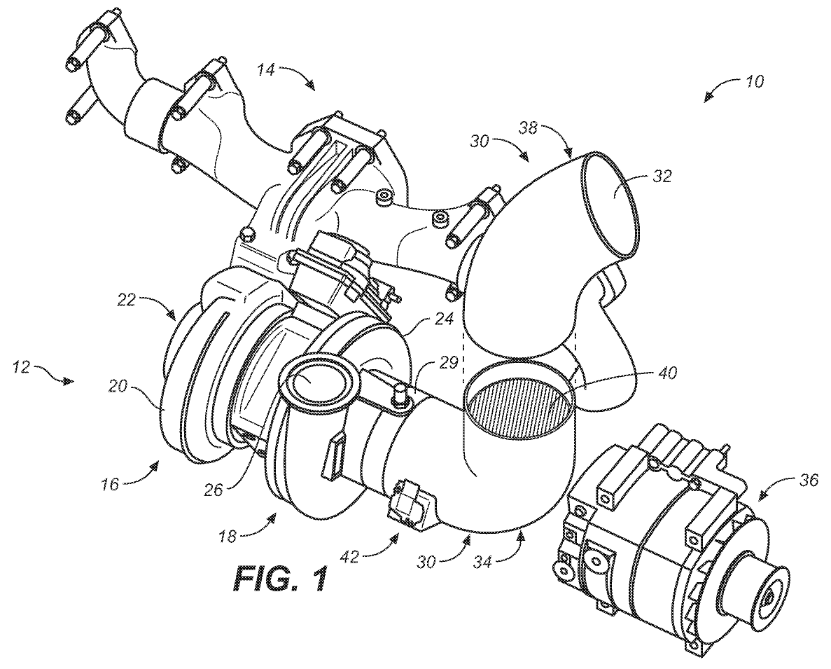

To more particularly describe the features of the present invention, please refer to FIGS. 1-5B in conjunction with the discussion below.

The present invention is an improved design for an adaptor including a mass air flow (MAF) sensor which can be placed in an air flow system for an engine in order to measure air flow accurately using the MAF sensor.

It is advantageous to have control systems and emission control devices that are not affected by the typical installation variations that are associated with the many vehicle makes and models or other types of mechanisms. The air flow sensing device described herein includes sensor and air flow components in a compact, optimized geometry that allows for the engine to be used in many different vehicles or other mechanisms with minimal sensor consistency variation and therefore minimal engine-out emissions variation.

FIG. 1 is a perspective view of an engine portion 10 that is a portion of an internal combustion engine including a mass air flow sensor adaptor of the present invention. The internal combustion engine of portion 10 can be used in a variety of applications, including automotive, off highway, power generation and marine (boat or ship) applications. In one useful application, the engine can be a standardized engine provided for use with a wide variety of different vehicles or other mechanisms, as allowed by the flexibility of the mass flow sensing system of the present invention. For example, an engine manufacturer that is not a vertically-integrated vehicle manufacturer can provide the standardized engine, i.e., a manufacturer that does not design and manufacture/assemble the entire vehicle or other mechanism (and all its air ducting).

In the described embodiment, engine portion 10 can include a turbocharger 12 connected to an exhaust manifold 14 of an internal combustion engine. The turbocharger 12 is used to convert waste energy from the exhaust manifold 14 into compressed air which the turbocharger pushes into the engine. This allows the engine to produce more power and torque and improves the overall efficiency of the combustion process.

The turbocharger 10 includes a turbine 16 and a compressor 18. The turbine includes a turbine wheel (not shown) and the collector or turbine housing 20. Exhaust gas from the exhaust manifold 14 is guided into the turbine wheel by the housing 20, such that the energy in the exhaust gas turns the turbine wheel. The gas passes through blades of the wheel and leaves the turbine housing 20 via the exhaust outlet area 22.

The compressor 18 includes an impeller or compressor wheel (not shown), and the compressor housing 24. The compressor wheel is connected to the turbine wheel of the turbine 16 by a shaft. As the compressor wheel spins, air is drawn in from an inlet housing 30 and is compressed as the blades spin at a high velocity. The compressor housing 24 converts the high velocity, low pressure air stream into a high pressure, low velocity air stream through diffusion, and leaves the compressor through an outlet 26.

An embodiment of the mass air flow sensor adaptor of the present invention includes inlet housing 30 connected to the compressor 18, e.g., by a band clamp 29 or other fastener attachment mechanism. The inlet housing 30 receives air flow at an opening 32 at the opposite end of the inlet housing 30 from the compressor 18, the air flow directed from outside the engine by a duct system, such that the air flows from the opening 32, through the inlet housing 30, to the compressor 18.

Inlet housing 30 includes an approximately 90-degree bend or elbow section 34. The 90-degree elbow section 34 includes an approximately 90-degree bend in the inlet housing 30, the 90 degrees provided between the inlet of the section 34 and the outlet of the section 34. In the described embodiment of FIG. 1, the 90-degree bend is also relative to the axis of rotation R of the turbine wheel in the turbine 16 and compressor wheel in the compressor 18. The 90-degree bend allows the inlet housing to fit into limited spaces in the engine, e.g., when located close to other components 36 of the engine.

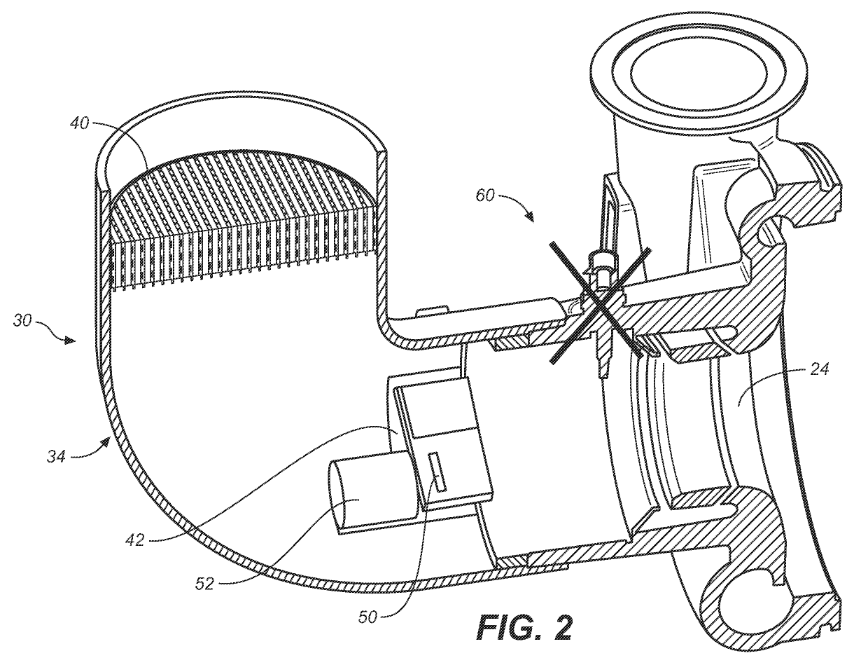

Inlet housing 30 includes a mass airflow (MAF) sensor in the 90-degree elbow section 34 of the inlet housing, which senses the air mass flowing past it. The MAF sensor is described in greater detail below with respect to FIGS. 2-5B. The sensor can be provided at a boss 42 provided in the molding of the inlet housing 30 or attached to the housing 30.

In some embodiments, the inlet housing 30 can include an approximately 45-degree bend or elbow section 38 provided at or near the opening 32 of the inlet housing 30. In the described embodiment, section 38 is provided closer to the opening 32 of inlet housing 30 than the 90-degree elbow section 34, such that it is positioned before the 90-degree section in the direction of airflow. 45-degree section 38 includes a bend of approximately 45 degrees from its inlet to its outlet. Section 38 can be provided as a separate piece from the other section 34 of the inlet housing 30 and attached to the other section, or can be integrated such that the housing 30 forms a single piece. The 45-degree section 38 can provide additional consistency and improved performance in air flow measurement ability of the sensor system of the present invention when preceding the 90-degree bend in the inlet air flow path. In some embodiments, the 45-degree section 38 is not used, due to available space in the engine area and/or configuration requirements.

In FIG. 1, 45-degree section 38 of inlet housing 30 is shown unattached or exploded from the 90-degree section 34 of the inlet housing 30 to show a honeycomb flow or air straightener 40 provided within the inlet housing 30 between the 45-degree section 38 and the 90-degree section 34 (or before the 90-degree section 34 relative to airflow direction, if no 45-degree section is present). The honeycomb flow straightener 40 reduces variation and turbulence in the airflow in the housing 30 and increases consistency of the MAF sensor, and can be implemented as any of a variety of available flow straighteners.

Although a sensor position close to a turbocharger (compressor inlet), as described above in the embodiment of FIG. 1, is an advantage from a packaging standpoint, the present invention of providing a sensor location relative to a 90 degree bend in the piping can also be provided further away from a turbocharger or other engine component. The components as an assembly (90 degree elbow, flow straightener, guide tube/housing and sensor) can be provided anywhere a 90 degree elbow is implemented for routing fresh air into the engine. Thus, in other embodiments, the inlet housing 30 used with the MAF sensor can be positioned at other locations within an air duct system providing air to an engine. For example, any approximately 90-degree elbow or bend in the piping of an engine air duct system can potentially be used, where the MAF sensor is placed at the outlet of the 90-degree bend similarly as described below for FIGS. 2-5B. In one example, a 90-degree bend in the ducting feeding from an air filter box of a vehicle to a throttle body of the air intake system, can be used in the present invention.

FIG. 2 is a perspective view of 90-degree elbow section 34 of the adaptor of the present invention as connected to the compressor 18 of FIG. 1. The 90-degree elbow section 34 can be molded out of a suitable material, such as rubber or plastic. For example, a rubber 90-degree section 34 can provide insulation from other components of the engine, and isolate the air flow and MAF sensor from the heat and vibration of the exhaust manifold 14.

An MAF sensor 50 is provided in the interior of the inlet housing 30. For example, the MAF sensor 50 can be connected to the boss 42 provided in the inlet housing 30, or can be otherwise attached to the housing 30. The MAF sensor 50 can be any of a variety of different types or brands of mass air flow sensors. For example, MAF sensor 50 can be a hot-wire gas flow sensor, which typically includes a temperature sensor. A different type of MAF sensor can also be used.

The MAF sensor 50 can measure the amount or mass of air flowing through the inlet housing 30 and provide a signal to an engine controller, for example an electronic control module or unit (ECM or ECU) (not shown) embedded in the engine, which can control characteristics and/or performance of the engine based on the sensed airflow. For example, the ECU receives an estimate of how much air is entering the engine, and can use other sensor inputs and the air flow measurement to determine a load on the engine, change the amount of fuel being sent to the fuel injectors to maintain a desired air-fuel ratio, determine when to ignite a cylinder, and/or perform other control functions.

An air inlet tube 52 can be provided adjacent to the MAF sensor 50 to channel air directly to the sensor 50. In one embodiment, the air inlet tube 50 can be molded as part of the 90-degree section 34 of the inlet housing, or molded as part of an overall inlet housing 30. Other embodiments can include a separately-fabricated air inlet tube 52 that is attached to the inlet housing 30 next to the sensor 50. The dimensions (e.g., diameter and length) of tube 52 can be based on the characteristics of the particular sensor 50 being used and based on the characteristics of the inlet housing 30, to optimize the stability of air flow that passes to the MAF sensor 50. In some embodiments, tubes of other cross-sectional shapes can be used, such as rectangular, oval, or other desired shapes.

Thus, the inlet housing 30 directs air from opening 32 to the compressor 18 (or other engine component). Tube 52 channels some of the air to the sensor 50, and the sensor 50 senses the air flow and provides output signals indicative of the amount or mass of air flow to a controller or other electronic device of the engine.

The location that the MAF sensor 50 is positioned within the inlet housing determines how stable is its air flow sensing capability for different air flow duct systems that may be connected to the inlet housing 30. Different locations in the inlet housing 30 may have different airflows depending on the duct system used. In the present invention, the MAF sensor 50 is located immediately after the 90-degree bend or elbow in the air duct inlet housing 30. This location has been found to provide an especially stable location to measure air flow consistently, regardless of the air flow duct system connected to the opening 32 of the inlet housing 30, and without the fluctuations and inconsistencies in flow measured at other locations in the duct. For example, in one embodiment the sensor 50 can be positioned within a distance equivalent to one times the inner diameter of the inlet tube or housing, from the airflow exit of the 90-degree elbow (the exit being the straight portion of the housing after the radius bend). The performance and consistency may degrade further away from the elbow exit, in some embodiments. The tube 52 provides additional consistency in airflow measurement of the sensor 50.

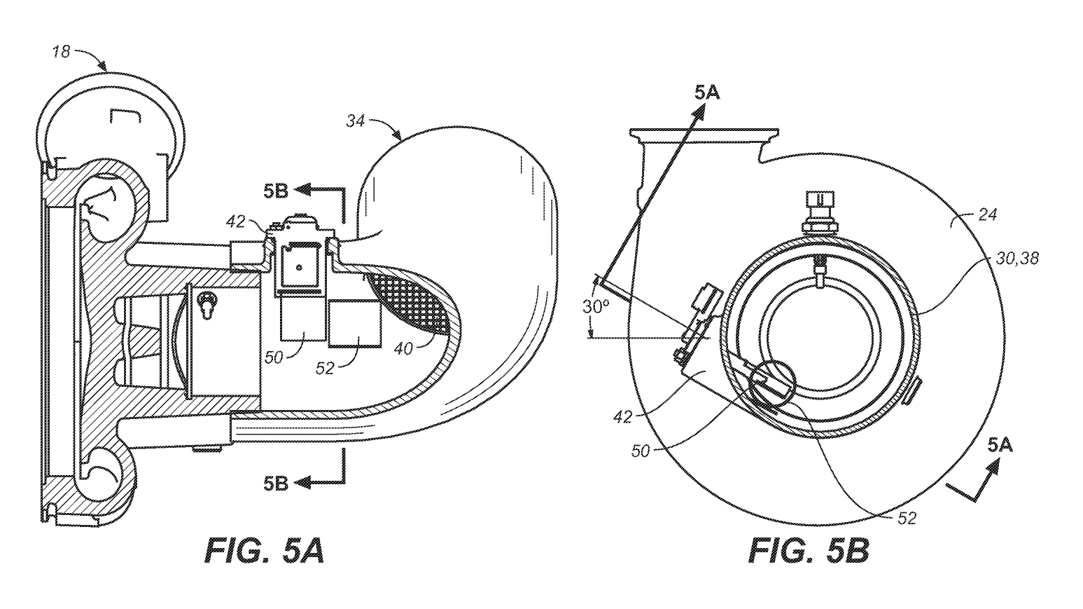

The orientation of the sensor 50 can also be important. The present invention allows the MAF sensor 50 to be angled sufficiently to drain water residue that collects on the sensor resulting from condensation from the air flow, and which can cause the sensor to fail unless the water is drained. The angling of the sensor is fully compatible with the increased consistency in airflow measurement achieved by the sensor location of the present invention in the inlet housing. One example of angling the sensor 50 is more clearly shown in FIG. 5B.

Outline 60 indicates the location that a separate temperature sensor would be needed if an MAF sensor 50 were not being used to measure airflow. The present invention allows such a temperature sensor, as well as a pressure sensor, to be omitted from the air flow sensing, thus saving significantly on the cost of the adaptor.

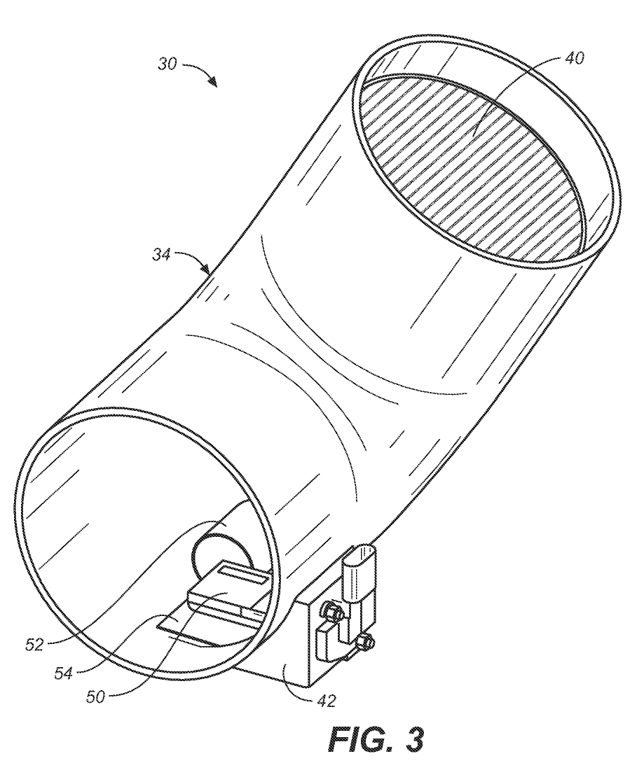

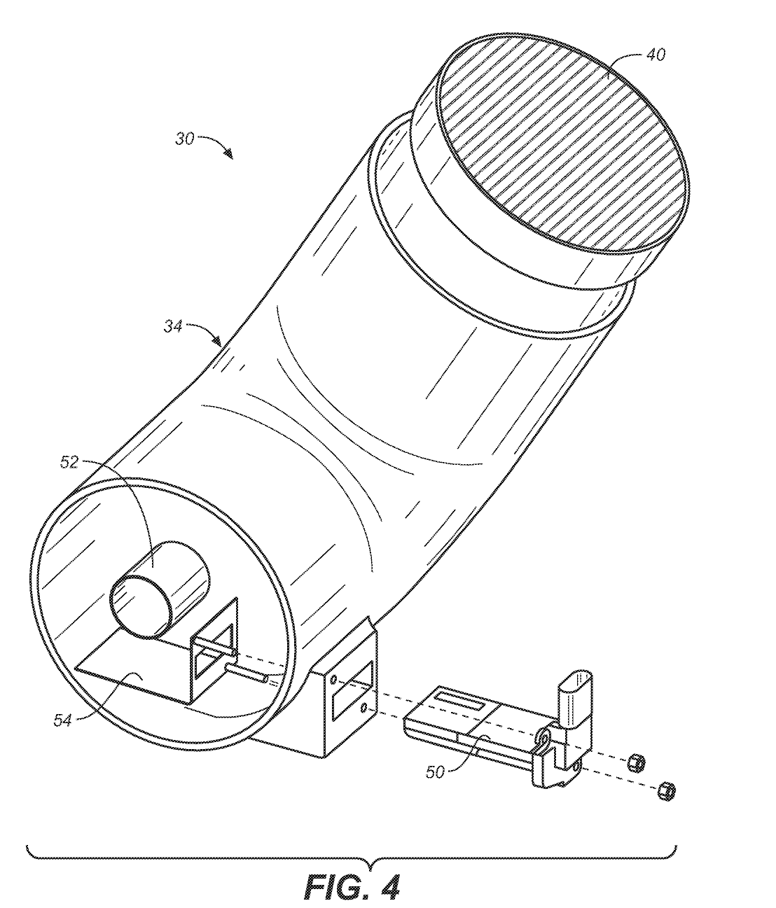

FIGS. 3 and 4 are perspective views of the 90-degree section 34 of the inlet housing 30, where FIG. 3 shows the MAF sensor 50 assembled and attached to the inlet housing 30, and FIG. 4 shows the MAF sensor 50 and attachment mechanism in an exploded view. FIGS. 5A and 5B are sectional views of a portion of the inlet housing 30 connected to the compressor 18 shown in the embodiment of FIG. 1.

In this embodiment, as shown in FIG. 4, the air flow tube 52 can be coupled to a support 54 that is coupled to the section 38 at boss 42. The MAF sensor 50 can be coupled to boss 42 to be positioned adjacent to the support 54 and tube 52.

In some embodiments the 90-degree section of the inlet housing 30 can be keyed to the connection of the compressor housing 24 to allow accurate orientation of the MAF sensor 50 with respect to ground and air flow. For example, engine OEM manufacturers that provide an engine for a variety of types of vehicles or other applications can be precise about the location of the sensor 50 using keying on the housing 30, or using a different alignment method, so that the sensor location and performance is consistent no matter what vehicle the engine is installed in or other application the engine is used for. For example, different types of vehicle may have a different kind of air inlet system that must be accommodated.

Honeycomb flow straightener 40 can be bonded to the 90-degree section using any of a variety of well known methods. Mass air flow sensor 50 is shown angled in FIG. 5B to allow water drainage from the sensor.

The present invention allows the use of a low-cost mass air flow sensor for a single engine product that can be used in any of a variety of vehicles and mechanisms, thus providing flexibility that accommodates variability in the air inlet and duct system connected to the engine. The use of a MAF sensor in an optimized location and orientation after a 90-degree elbow in an inlet duct, allows a variety of different air flow inputs and ducting to be used with the present invention without causing fluctuations or inconsistencies in air flow measurement results. The use of a honeycomb air flow straightener before the 90-degree elbow, and a 45-degree elbow provided before the 90-degree elbow, further increases the accuracy and consistency of MAF sensor readings.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A sensor adaptor for use in an internal combustion engine, the adaptor comprising:
an inlet housing including an approximately 90-degree elbow and directing air within the inlet housing to the internal combustion engine in an airflow direction; and
a mass air flow sensor coupled to the housing at a location after the 90-degree elbow with respect to the airflow direction and sensing the air flowing within the inlet housing.

2. The sensor adaptor of claim 1 wherein the mass air flow sensor is provided at a location in the inlet housing immediately after the 90-degree elbow with respect to the airflow direction.

3. The sensor adaptor of claim 1 wherein the mass air flow sensor is positioned within a distance equivalent to one times the inner diameter of the inlet housing, from an airflow exit of the 90-degree elbow.

4. The sensor adaptor of claim 1 further comprising an air inlet tube provided adjacent to the mass air flow sensor, the air inlet tube channeling the air to the mass air flow sensor.

5. The sensor adaptor of claim 4 wherein the dimensions of the air inlet tube are based on the characteristics of the mass air flow sensor.

6. The sensor adaptor of claim 4 wherein the air inlet tube is molded into the housing.

7. The sensor adaptor of claim 1 further comprising a flow straightener coupled to the inlet housing and provided in front of the 90-degree elbow with respect to the airflow direction, the flow straightener reducing turbulence in the air flow within the inlet housing.

8. The sensor adaptor of claim 1 wherein the inlet housing includes an approximately 45-degree elbow located in front of the 90-degree elbow with respect to the airflow direction.

9. The sensor adaptor of claim 1 wherein the inlet housing is coupled to a turbocharger of the internal combustion engine at an outlet of the inlet housing, such that the inlet housing directs air to the turbocharger.

10. An engine system comprising:
an engine;
an inlet housing including an approximately 90-degree elbow and directing air within the inlet housing to the engine in an airflow direction; and
a mass air flow sensor coupled to the housing at a location after the 90-degree elbow with respect to the airflow direction and sensing the air flowing within the inlet housing.

11. The engine system of claim 10 wherein the mass air flow sensor is positioned within a distance equivalent to one times the inner diameter of the inlet housing, from an airflow exit of the 90-degree elbow.

12. The engine system of claim 10 further comprising an air inlet tube provided adjacent to the mass air flow sensor, the air inlet tube channeling the air to the mass air flow sensor, wherein the dimensions of the air inlet tube are based on the characteristics of the mass air flow sensor.

13. The engine system of claim 10 further comprising a flow straightener coupled to the inlet housing and provided in front of the 90-degree elbow with respect to the airflow direction, the flow straightener reducing turbulence in the air flow within the inlet housing.

14. The engine system of claim 13 wherein the inlet housing includes an approximately 45-degree elbow located in front of the 90-degree elbow and in front of the flow straightener with respect to the airflow direction.

15. The engine system of claim 10 wherein the inlet housing is coupled to a turbocharger of the engine at an outlet of the inlet housing, such that the inlet housing directs air to the turbocharger.

16. A method for sensing airflow in an internal combustion engine, the method comprising:
directing air within an inlet housing to the internal combustion engine in an airflow direction, the inlet housing including an approximately 90-degree elbow; and
sensing the air flowing within the inlet housing a mass air flow sensor coupled to the housing at a location after the 90-degree elbow with respect to the airflow direction.

17. The method of claim 16 wherein the mass air flow sensor is positioned within a distance equivalent to one times the inner diameter of the inlet housing, from an airflow exit of the 90-degree elbow.

18. The method of claim 16 further comprising an air inlet tube provided adjacent to the mass air flow sensor, the air inlet tube channeling the air to the mass air flow sensor.

19. The method of claim 18 wherein the dimensions of the air inlet tube are based on the characteristics of the mass air flow sensor.

20. The method of claim 16 further comprising a flow straightener coupled to the inlet housing and provided in front of the 90-degree elbow with respect to the airflow direction, the flow straightener reducing turbulence in the air flow within the inlet housing.

21. The method of claim 16 wherein the inlet housing includes an approximately 45-degree elbow located in front of the 90-degree elbow with respect to the airflow direction.
